(19) United States
(12) Patent Application Publication
(10) Pub. No.: US 2012/0320883 A1
(43) Pub. Date: Dec. 20, 2012

(54) METHOD FOR TRANSMITTING ACK/NACK INFORMATION TO UPLINK PHYSICAL CONTROL CHANNEL

(75) Inventors: Bang Won Seo, Daejeon (KR); Young Jo Ko, Daejeon (KR); Byung Jang Jeong, Daejeon (KR)

(73) Assignee: Electronics and Telcommunications Research Institute, Daejeon (KR)

(21) Appl. No.: 13/520,946

(22) PCT Filed: Jan. 7, 2011
(86) PCT No.: PCT/KR2011/000126

§ 371 Date: Jul. 6, 2012

(30) Foreign Application Priority Data
Jan. 7, 2010 (KR) 10-2010-0001343
Feb. 11, 2010 (KR) 10-2010-0012745

(51) Int. Cl. H04W 72/04

(52) U.S. Cl. 370/336

(57) ABSTRACT

Disclosed is a communication system which transmits Acknowledgement (ACK)/Negative Acknowledgement (NACK) information on downlink data by using an uplink control channel. The communication system individually allocates radio resources for a plurality of slots included in an uplink subframe. Consequently, uplink radio resources may be used freely, and it is even possible to flexibly handle a situation in which the amount of the ACK/NACK information is increased.

### TECHNICAL FIELD

The present invention relates to a method for transmitting transmission verification information, and more particularly, to a method for transmitting transmission verification information via an uplink physical control channel.

### BACKGROUND ART

An amount of signals transmitted using a wireless communication network has been gradually increased over time. It is expected in the near future that a signal with a capacity several times than that of a currently transmitted signal will be transmitted using a wireless communication network.

When a base station transmits data to a terminal, the terminal may determine whether data transmission succeeds, and may transmit, to the base station, information regarding success or failure of the data transmission. When the data transmission fails, the base station may retransmit the data, to improve reliability of the data transmission.

When a capacity of downlink data is increased, an amount of information regarding whether transmission of data transmitted by the terminal to the base station succeeds may also be increased. Accordingly, there is a need to flexibly allocate a greater amount of radio resources used to transmit information regarding whether the transmission succeeds.

### DISCLOSURE OF INVENTION

### Technical Goals

An aspect of the present invention provides a method for transmitting Acknowledgement (ACK)/Negative Acknowledgement (NACK) information associated with downlink data, using an uplink component carrier.

An aspect of the present invention provides a method for simultaneously transmitting a plurality of ACK/NACK symbols, using an uplink component carrier.

### Technical solutions

According to an aspect of the present invention, there is provided a method for transmitting transmission verification information, the method including: generating transmission verification information associated with data, the data being received from a base station; individually allocating radio resources to a plurality of slots included in an uplink subframe; and transmitting the transmission verification information to the base station using the allocated radio resources.

According to another aspect of the present invention, there is provided a method for receiving transmission verification information, the method including: transmitting data to a terminal; and receiving transmission verification information to associated with the data using radio resources, the radio resources being individually allocated to a plurality of slots included in an uplink subframe.

According to still another aspect of the present invention, there is provided a method for transmitting transmission verification information, the method including: generating a plurality of radio resource groups with radio resources; selecting a radio resource from among each of the plurality of generated radio resource groups, combining selected radio resources, and individually allocating radio resources to a plurality of slots included in an uplink subframe; and transmitting, to a base station, transmission verification information associated with data using the allocated radio resources, the data being received from the base station.

### Effect of the Invention

According to embodiments of the present invention, it is possible to transmit Acknowledgement (ACK)/Negative Acknowledgement (NACK) information associated with downlink data, using an uplink component carrier.

According to embodiments of the present invention, it is possible to simultaneously transmit a plurality of ACK/NACK symbols, using an uplink component carrier.

### BRIEF DESCRIPTION OF DRAWINGS

FIG. 1 is a diagram illustrating a structure of an uplink subframe where radio resources used to transmit transmission verification information are allocated;

FIG. 2 is a diagram illustrating a structure of a Physical Resource Block (PRB) that transmits transmission verification information;

FIG. 3 is a diagram illustrating an example in which two physical radio resource blocks are allocated for each slot, to transmit transmission verification information;

FIG. 4 is a diagram illustrating of an example of transmitting transmission verification information using a plurality of uplink component carriers;

FIG. 5 is a flowchart illustrating a method for transmitting transmission verification information according to an example embodiment of the present invention;

FIG. 6 is a flowchart illustrating a method for receiving transmission verification information according to an example embodiment of the present invention; and

FIG. 7 is a flowchart illustrating a method for transmitting transmission verification information according to another example embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

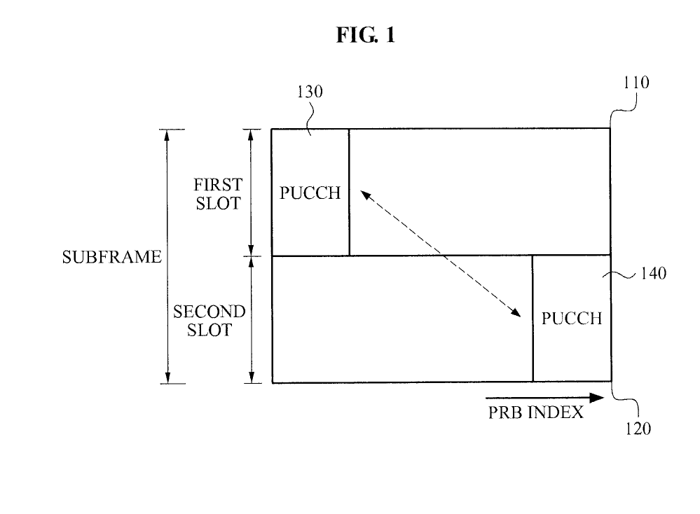

FIG. 1 is a diagram illustrating a structure of an uplink subframe where radio resources used to transmit transmission verification information are allocated.

A base station may transmit data to a terminal using a downlink subframe. The terminal may generate transmission verification information associated with downlink data. The transmission verification information may be information indicating whether transmission of the downlink data succeeds. When data transmission succeeds, transmission verification information may have a value of Acknowledgement (ACK). When the data transmission fails, the transmission verification information may have a value of Negative Acknowledgement (NACK). Additionally, when the terminal does not recognize even whether the base station transmits data, the transmission verification information may have a value of Discrete Transmission (DTX).

The terminal may transmit the transmission verification information to the base station, using an uplink subframe.

A single subframe may include two slots, for example, a first slot 110 and a second slot 120. Control channels 130 and 140 used to transmit a single transmission verification information symbol may be transmitted during a single subframe period in a time domain, and may be transmitted using a single Physical Resource Block (PRB) in a frequency domain.

According to an aspect, when the present invention is applied to the 3rd Generation Partnership Project (3GPP) standard, a control channel may be a Physical Uplink Control Channel (PUCCH).

According to an aspect, a single PRB may include a plurality of subcarriers. When the present invention is applied to the 3GPP standard, a single PRB may include 12 subcarriers in a frequency domain. A frequency domain position of a PRB (namely, a PRB index for each slot) that is used by the terminal to provide transmission verification information as feedback to the base station may be provided from the base station. For example, in FIG. 1, a PRB index for each slot may include (n₁, n₄). In other words, when an n₁-th PRB is used in the first slot 110, an n₄-th PRB may necessarily be used in the second slot 120.

According to an aspect, the control channels 130 and 140 respectively allocated to the slots 110 and 120 may be allocated to PRBs that are associated with each other. For example, to obtain a frequency diversity, the control channel 130 allocated to the first slot 110, and the control channel 140 allocated to the second slot 120 may use PRBs that are far away from each other in a frequency domain. Such a characteristic may be referred to as “frequency hopping.”

When the control channel 130 allocated to the first slot 110 is connected with the control channel 140 allocated to the second slot 120, allocating radio resources to the first slot 110 and the second slot 120 may be restricted. Additionally, an amount of transmission verification information is increased, it may be difficult to allocate a greater amount of radio resources.

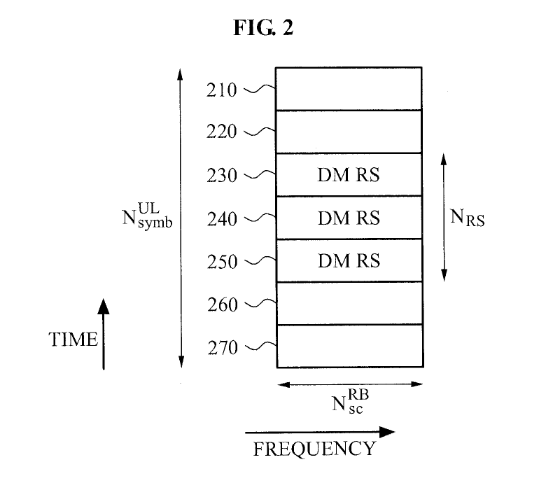

FIG. 2 is a diagram of a structure of a PRB that transmits transmission verification information.

The PRB shown in FIG. 2 may form the control channels 130 and 140 shown in FIG. 1. The PRB may include N_{symb}^{UL} symbols 210, 220, 230, 240, 250, 260, and 270. Among the N_{symb}^{UL} symbols 210, 220, 230, 240, 250, 260, and 270, N_{RS} symbols 230, 240, and 250 may be used to transmit a reference signal for demodulation. The other symbols, namely, N_{A}=(N_{symb}^{UL}−N_{RS}) symbols 210, 220, 260, and 270 may be used to transmit the transmission verification information.

Accordingly, resources used to transmit the transmission verification information may include N_{A} symbols in a time domain, and N_{sc}^{RB} subcarriers in a frequency domain. Additionally, a transmission verification information symbol may be transmitted by multiplying a two-dimensional (2D) spreading code. In other words, a spreading code having a length of N_{sc}^{RB} in the frequency domain may be multiplied, and a spreading code having a length of N_{A} in the time domain may be multiplied.

Here, the spreading code in the frequency domain may change a Cyclic Shift (CS) value for a single basic spreading code, and may generate a new code. In other words, two different frequency-domain spreading codes may correspond to two different CS values.

The terminal may form a control channel using a PRB index for each slot, a CS value, and a time-domain spreading code index that are provided from the base station, and may provide, as feedback, the transmission verification information to the base station using the formed control channel.

According to an aspect, to provide, as feedback, the transmission verification information to the base station, the terminal may receive, from the base station, information on available radio resources. The available radio resources may refer to all radio resources that may be selected by the terminal to provide the transmission verification information as feedback. The terminal may select radio resources used to transmit the transmission verification information, from among the available radio resources.

According to an aspect, available radio resources may refer to one of a PRB index, a frequency-domain spreading code, and a time-domain spreading code, or a combination thereof. Since the PRB index may refer to an index of subcarriers included in a radio resource block, the PRB index may be briefly regarded as information regarding a frequency domain.

According to an aspect, the terminal may generate a plurality of radio resource groups that respectively include available radio resources. For example, the terminal may generate a set “A={CS₁, CS₂, . . . , CS_{M}}” of available CS values, a set “B={W₁, W₂, . . . , W_{N}}” of available time-domain spreading code indexes, a set “C₁={u_{1,1}, u_{1,2}, . . . , u_{1,L}}” of PRB indexes available in a first slot, and a set “C₂={u_{2,1}, u_{2,2}, . . . , u_{2,L}}” of PRB indexes available in a second slot.

According to an aspect, the terminal may select a single radio resource from each of the sets A, B, C, and D. In other words, the same CS value and the same time-domain spreading code may be used based on a selection of the terminal, however, different CS values and different time-domain spreading codes may be used in each slot. Additionally, when a first PRB index is selected in the first slot, a second PRB index may also be used in the second slot, regardless of the first PRB index.

As described above, selecting a radio resource in the second slot, regardless of a value of a radio resource selected in the first slot may refer to individually selecting radio resources.

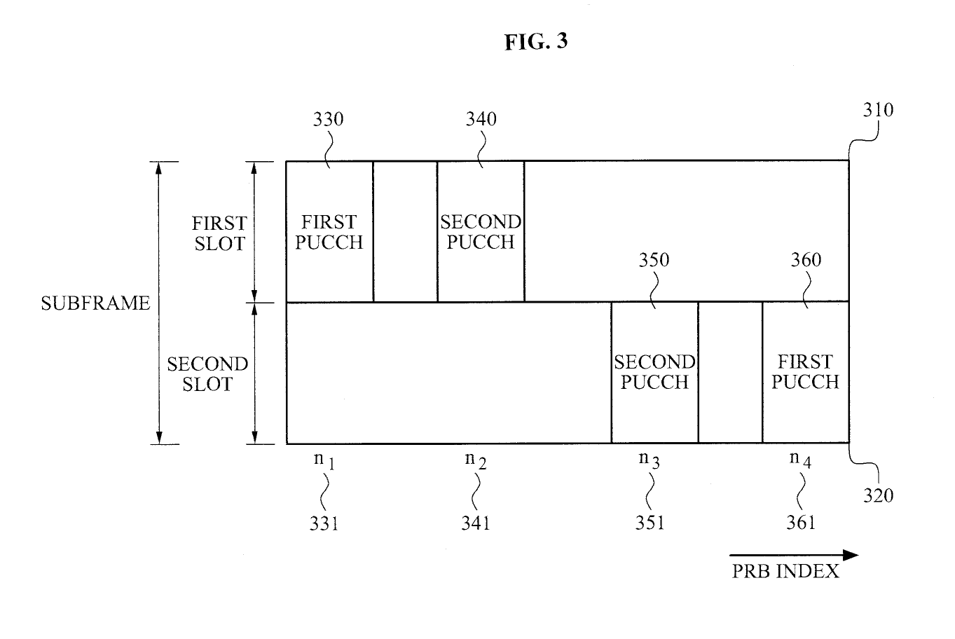

FIG. 3 is a diagram illustrating an example in which two physical radio resource blocks are allocated for each slot, to transmit transmission verification information.

When two physical radio resource blocks are allocated for each slot, two control channels may be transmitted for each slot.

According to an aspect, a terminal may select either a first control channel 330 or a second control channel 340 in a first slot 310, and may select either a third control channel 350 or a fourth control channel 360 in a second slot 320.

In other words, regardless of which PRB index is selected from between n₁ 331 and n₂ 341 in the first slot 310, the PRB index selected in the first slot 310 may have no influence on which PRB index is selected from between n₃ 351 and n₄ 361 in the second slot 320. Accordingly, the terminal may select a combination from among four combinations formed with n₁ 331, n₂ 341, n₃ 351, and n₄ 361.

The example in which two slots are included in a single subframe has been merely described with reference to FIGS. 2 and 3. However, another embodiment of the present invention may equally be applied to an example in which at least three slots are included in a subframe.

Additionally, the example in which two control channels are transmitted for each slot has been merely described with reference to FIG. 3. However, another embodiment of the present invention may equally be applied to an example in which at least three control channels are transmitted for each slot.

According to an aspect, the terminal may determine radio resources based on a value of transmission verification information. Accordingly, the terminal may use a resource mapping table. For example, values of two pieces of transmission verification information may be assumed to be {Q1, Q2}. A mapping table with respect to {CSₘ₁, Wₙ₁, u_{1,p1}, u_{2,q1}} may be generated with respect to all possible combinations of {Q1, Q2}, and {CSₘ₁, Wₙ₁, u_{1,p1}, u_{2,q1}} may be selected from the mapping table based on values of {Q1, Q2}. For example, when Q1=ACK and Q2=NACK, the terminal may transmit transmission verification information using {CSₘ, Wₙ, u_{1,p}, u_{2,q}} in a radio resource mapping table.

According to an aspect, the base station may search for, from control information, at least one of a CS value, and time-domain spreading code information that are used by the terminal, and may determine (Q1, Q2). Additionally, the base station may search for at least one of a CS value, time-domain spreading code information, and PRB index information that are used by the terminal, and may determine (Q1, Q2).

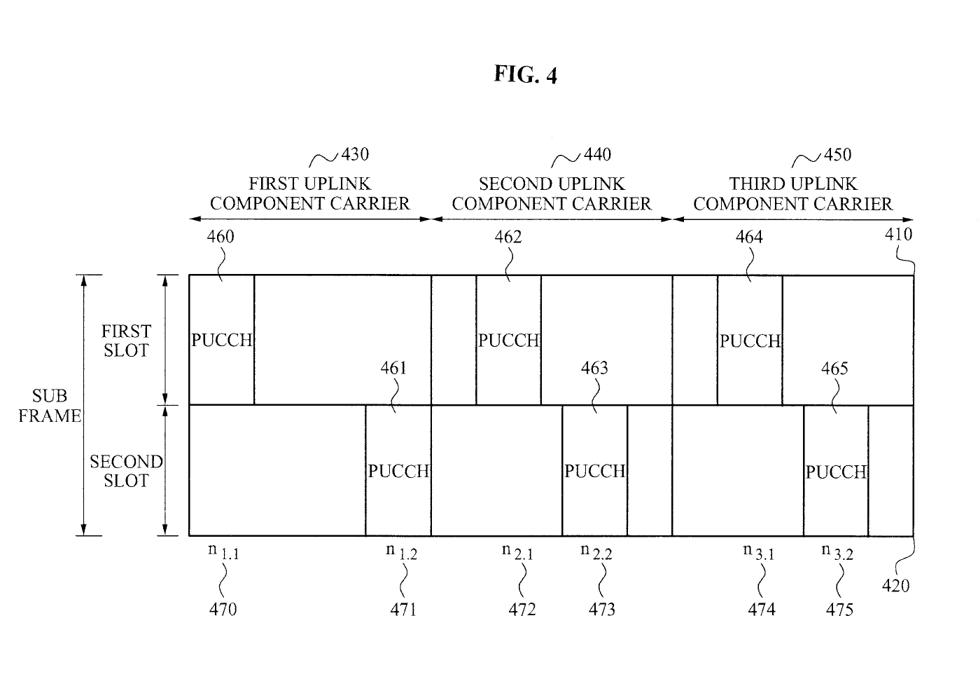

FIG. 4 is a diagram illustrating of an example of transmitting transmission verification information using a plurality of uplink component carriers.

A terminal may transmit transmission verification information using radio resources included in a plurality of uplink component carriers, for example a first uplink component carrier 430, a second uplink component carrier 440, and a third uplink component carrier 450.

To transmit the transmission verification information, the terminal may select a single index from among PRB indexes {n_{1,1}, n_{2,1}, n_{3,1}} in a first slot 410. Additionally, the terminal may select a single index from among PRB indexes {n_{1,2}, n_{2,2}, n_{3,2}} in a second slot 420. In other words, the terminal may select a single combination from among nine combinations, and may transmit the transmission verification information. Here, the nine combinations may be formed with a first radio resource 460, a third radio resource 462, a fifth radio resource 464, a second radio resource 461, a fourth radio resource 463, a sixth radio resource 465.

According to an aspect, the terminal may select a CS value, and a time-domain spreading code index, with respect to each of the first slot 410 and the second slot 420, from among values available in the plurality of uplink component carriers where each of the first slot 410 and the second slot 420 belongs.

In the embodiment shown in FIG. 4, the terminal may determine radio resources based on the value of the transmission verification information, and the base station may determine the value of the transmission verification information based on radio resources.

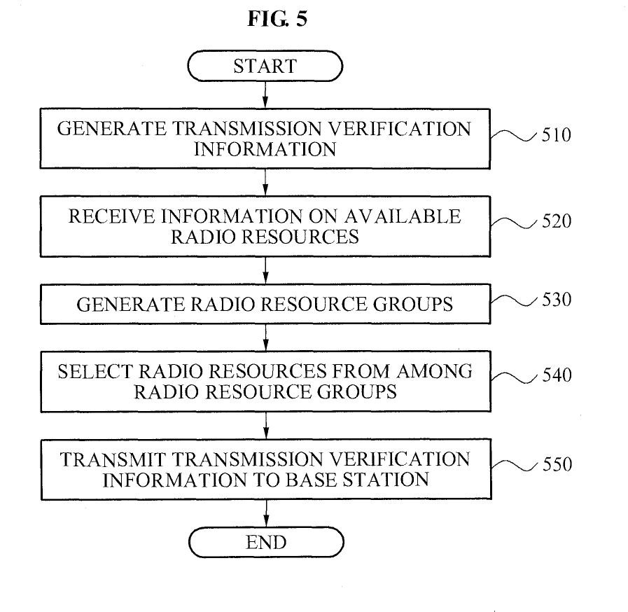

FIG. 5 is a flowchart illustrating a method for transmitting transmission verification information according to an example embodiment of the present invention.

In operation 510, a terminal may receive downlink data from a base station, and may determine whether transmission of the downlink data succeeds. Additionally, the terminal may generate information regarding whether the transmission of the downlink data succeeds.

The transmission verification information may be information indicating whether the transmission of the downlink data succeeds. When data transmission succeeds, transmission verification information may have a value of ACK. When the data transmission fails, the transmission verification information may have a value of NACK. Additionally, when the terminal does not recognize even whether the base station transmits data, the transmission verification information may have a value of DTX.

In operation 520, the terminal may receive, from the base station, information on available radio resources. The available radio resources may be used by the terminal to transmit the transmission verification information to the base station. The terminal may select radio resources used to transmit the transmission verification information, from among the available radio resources.

Here, the radio resources may include at least one of a PRB index, a CS value, and a time-domain spreading code index.

The terminal may individually allocate radio resources to a plurality of slots included in an uplink subframe. Here, the “individually allocating” may refer to selecting a radio resource in a second slot, regardless of a value of a radio resource selected in a first slot. Accordingly, the radio resource selected by the terminal from the first slot may not be connected with the radio resource selected by the terminal from the second slot.

For example, in operation 530, the terminal may generate a plurality of radio resource groups that include radio resources. The terminal may individually generate a first radio resource group including PRB indexes available in each of the slots, a second radio resource group including CS values available in each of the slots, and a third radio resource group including time-domain spreading code indexes available in each of the slots.

In operation 540, the terminal may select radio resources from among the plurality of radio resource groups.

The terminal may select the PRB indexes for each of the slots from the first radio resource group, may select the CS values for each of the slots from the second radio resource group, and may select the time-domain spreading code indexes for each of the slots from the third radio resource group.

In operation 540, the terminal may individually select radio resources with respect to each of the slots. Accordingly, the terminal may select the same radio resource with respect to each of the slots, or conversely may select different radio resources with respect to each of the slots. Regardless of a value of a radio resource selected for a single slot, the terminal may select a radio resource for another slot.

According to an aspect, the terminal may allocate radio resources based on the value of the transmission verification information. For example, when transmission verification information to be transmitted in a first slot has a value of ‘ACK’, the terminal may select a first radio resource in the first slot. Conversely, when the transmission verification information to be transmitted in the first slot has a value of ‘NACK’, the terminal may select a second radio resource in the first slot.

In operation 550, the terminal may transmit the transmission verification information to the base station, using the radio resources allocated to each of the slots.

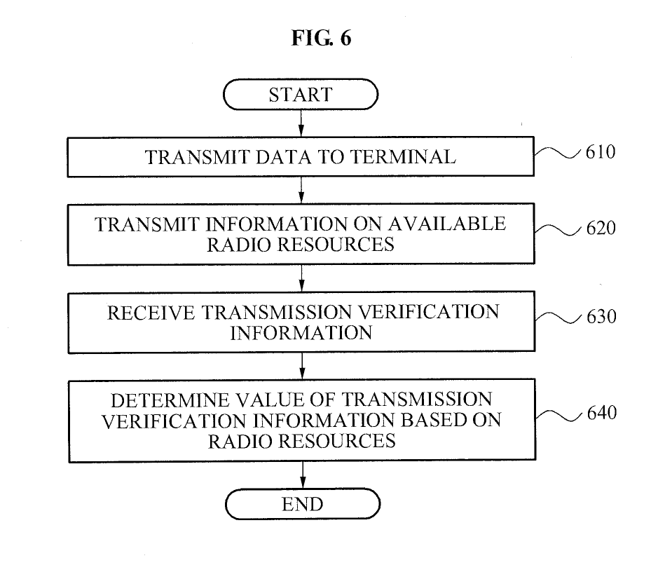

FIG. 6 is a flowchart illustrating a method for receiving transmission verification information according to an example embodiment of the present invention.

In operation 610, a base station may transmit downlink data to a terminal.

In operation 620, the base station may transmit, to the terminal, information on available radio resources.

The available radio resource may refer to radio resources used by the terminal to transmit the transmission verification information to the base station.

The transmission verification information may be information indicating whether transmission of the data transmitted in operation 610 succeeds. When data transmission succeeds, the transmission verification information may have a value of ACK. When the data transmission fails, the transmission verification information may have a value of NACK. Additionally, when the terminal does not recognize even whether the base station transmits data, the transmission verification information may have a value of DTX.

The radio resources may include at least one of a PRB index, a CS value, and a time-domain spreading code index.

The terminal may select radio resources used to transmit transmission verification information to the base station, from among the available radio resources. According to an aspect, the terminal may individually allocate radio resources to a plurality of slots included in an uplink subframe. The “individually allocating” may refer to selecting a radio resource in a second slot, regardless of a value of a radio resource selected in a first slot.

In operation 630, the base station may receive the transmission verification information from the terminal, using the radio resources allocated by the terminal.

According to an aspect, the terminal may allocate radio resources based on the value of the transmission verification information. Here, in operation 640, the base station may determine the value of the transmission verification information based on the radio resources allocated by the terminal.

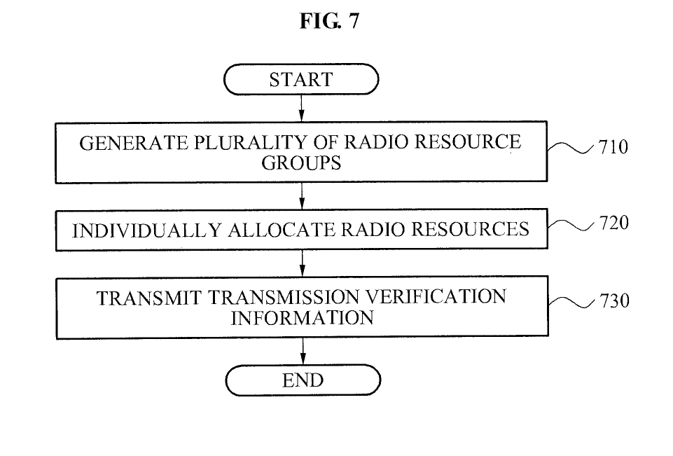

FIG. 7 is a flowchart illustrating a method for transmitting transmission verification information according to another example embodiment of the present invention.

In operation 710, a terminal may generate a plurality of radio resource groups that include radio resources. Here, the radio resources may include at least one of a PRB index, a CS value, and a time-domain spreading code index.

For example, the terminal may generate a set “A={CS₁, CS₂, . . . , CS_{M}}” of available CS values, and a set “B={W₁, W₂, . . . , W_{N}}” of available time-domain spreading code indexes.

When different radio resources are available in each of slots included in an uplink subframe, the terminal may generate radio resource groups for each of the slots. In other words, the terminal may generate a set “C₁={u_{1,1}, u_{1,2}, . . . , u_{1,L}}” of PRB indexes available in a first slot, and a set “C₂={u_{2,1}, u_{2,2}, . . . , u_{2,L}}” of PRB indexes available in a second slot.

In operation 720, the terminal may select a radio resource from among each of the plurality of radio resource groups. In other words, the terminal may select CS₁ from the set A of the CS values, and may select W₁ from the set B of the time-domain spreading code indexes, with respect to the first slot. Additionally, the terminal may select CS₂ from the set A of the CS values, and may select W₂ from the set B of the time-domain spreading code indexes, with respect to the second slot.

Additionally, the terminal may combine the selected radio resources, and may individually allocate radio resources to each of the slots included in the uplink subframe. Here, the “individually allocating” may mean that a value of a radio resource selected for the first slot is not connected with a value of a radio resource selected for the second slot. Accordingly, which radio resource is selected for the second slot may not be predicted, even when the terminal selects a first radio resource for the first slot.

In operation 730, the terminal may transmit, to the base station, transmission verification information associated with downlink data received from the base station, using the allocated radio resources. The transmission verification information may indicate whether transmission of the downlink data succeeds. For example, when the data transmission succeeds, the transmission verification information may have a value of ACK. When the data transmission fails, the transmission verification information may have a value of NACK. Additionally, when the terminal does not recognize even whether the base station transmits the data, the transmission verification information may have a value of DTX.

According to an aspect, in operation 720, the terminal may allocate the radio resources based on the value of the transmission verification information. For example, when transmission verification information to be transmitted in the first slot has a value of ‘ACK’, the terminal may select a first radio resource in the first slot. Conversely, when the transmission verification information to be transmitted in the first slot has a value of ‘NACK’, the terminal may select a second radio resource in the first slot.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method for transmitting transmission verification information, the method comprising:
generating transmission verification information associated with data, the data being received from a base station;
individually allocating radio resources to a plurality of slots comprised in an uplink subframe; and
transmitting the transmission verification information to the base station using the allocated radio resources.

2. The method of claim 1, wherein the transmission verification information comprises one of an Acknowledgement (ACK) message indicating a success of a reception of the data, a Negative Acknowledgement (NACK) message indicating a failure of the reception of the data, and a Discrete Transmission (DTX) message indicating that verifying of the success or the failure is impossible.

3. The method of claim 1, further comprising:
receiving information on available radio resources from the base station,
wherein the individually allocating comprises allocating, to the plurality of slots, radio resources among the available radio resources.

4. The method of claim 1, wherein the radio resources comprise at least one of an index of a Physical Resource Block (PRB), a value of a Cyclic Shift (CS), and an index of a time-domain spreading code.

5. The method of claim 3, wherein the individually allocating comprises:
generating a plurality of radio resource groups with the radio resources; and
selecting a radio resource from among each of the plurality of generated radio resource groups, and allocating the selected radio resource.

6. The method of claim 1, wherein the individually allocating comprises allocating different radio resources to the plurality of slots.

7. The method of claim 1, wherein the individually allocating comprises allocating the radio resources based on a value of the transmission verification information.

8. A method for receiving transmission verification information, the method comprising:
transmitting data to a terminal; and
receiving transmission verification information associated with the data using radio resources, the radio resources being individually allocated to a plurality of slots comprised in an uplink subframe.

9. The method of claim 8, the transmission verification information comprises one of an Acknowledgement (ACK) message indicating a success of a reception of the data, a Negative Acknowledgement (NACK) message indicating a failure of the reception of the data, and a Discrete Transmission (DTX) message indicating that verifying of the success or the failure is impossible.

10. The method of claim 8, further comprising:
transmitting information on available radio resources to the terminal,
wherein the individually allocated radio resources are comprised in the available radio resources.

11. The method of claim 8, wherein the radio resources comprise at least one of an index of a Physical Resource Block (PRB), a value of a Cyclic Shift (CS), and an index of a time-domain spreading code.

12. The method of claim 8, further comprising:
determining a value of the transmission verification information based on the individually allocated radio resources.

13. A method for transmitting transmission verification information, the method comprising:
generating a plurality of radio resource groups with radio resources;
selecting a radio resource from among each of the plurality of generated radio resource groups, combining selected radio resources, and individually allocating radio resources to a plurality of slots comprised in an uplink subframe; and
transmitting, to a base station, transmission verification information associated with data using the allocated radio resources, the data being received from the base station.

14. The method of claim 13, the transmission verification information comprises one of an Acknowledgement (ACK) message indicating a success of a reception of the data, a Negative Acknowledgement (NACK) message indicating a failure of the reception of the data, and a Discrete Transmission (DTX) message indicating that verifying of the success or the failure is impossible.

15. The method of claim 13, wherein the radio resources comprise at least one of an index of a Physical Resource Block (PRB), a value of a Cyclic Shift (CS), and an index of a time-domain spreading code.

16. The method of claim 13, wherein the selecting comprises allocating the radio resources based on a value of the transmission verification information.
